(19) United States
(12) Patent Application Publication
(10) Pub. No.: US 2009/0046395 A1
(43) Pub. Date: Feb. 19, 2009

(54) MAGNETORESISTIVE EFFECT THIN-FILM MAGNETIC HEAD AND METHOD FOR FABRICATING SAME

(75) Inventors: Hiroki Maehara, Kanagawa (JP); David D. Djayaprawira, Kanagawa (JP); Naoki Watanabe, Kanagawa (JP)

Correspondence Address: BUCHANAN, INGERSOLL & ROONEY PC, POST OFFICE BOX 1404, ALEXANDRIA, VA, 22313-1404, US

(73) Assignee: Canon ANELVA Corporation, Kanagawa (JP)

(21) Appl. No.: 12/282,361

(22) PCT Filed: Feb. 23, 2007
(86) PCT No.: PCT/JP2007/053392

§ 371 Date: Oct. 17, 2008

(30) Foreign Application Priority Data
Mar. 10, 2006 (JP) 2006-065820

(51) Int. Cl. G11B 5/33

(52) U.S. Cl. 360/319; G9B/5.104

(57) ABSTRACT

A magnetoresistive effect thin-film magnetic head including a magnetoresistive effect element having a CPP structure in which the gap length can be precisely optimized and a method for fabricating the magnetoresistive effect thin-film magnetic head are provided. The stacked magnetoresistive effect thin-films having the cap layer as the top layer are formed on the bottom shield layer. The soft magnetic layer consisting of any soft magnetic material is then formed on the cap layer, and the micro fabrication process is performed. Subsequently, at least one insulating layer is formed on the stacked magnetoresistive effect thin-films after the micro fabrication process, having the cap layer as the top layer, on which the soft magnetic layer is formed. Then, the soft magnetic layer is exposed by removing a part of the insulating layer formed on the soft magnetic layer and the top shield layer is formed on the surface of the exposed soft magnetic layer.

### BACKGROUND

1. Technical Field

Generally, the present disclosure applies to the apparatus that provides the high-density recording and reproducing functions for the magnetic recording medium on the magnetic disk device, such as HDD devices and the like. More particularly, the present disclosure relates to a magnetoresistive effect thin-film magnetic head having its gap length that can be optimized with a high precision, and a method for fabricating such magnetoresistive effect thin-film magnetic heads.

2. Background

As the storage capacity of the HDD device is becoming larger with its physical size becoming smaller, there are increasing demands for the thin-film magnetic heads that provides the high sensitivity and high output performance. Particularly, there are more needs for the improved processing speed and increased storage capacity for the magnetic recording medium on the magnetic storage devices, such as the HDD devices and the like. In order to meet those needs, more efforts have been made to achieve the high recording density for the magnetic recoding medium.

In the recent years, the magnetoresistive effect thin-film magnetic head that includes the stacked magnetoresistive effect thin-films (referred to hereinafter as “stacked MR films”) such as TMR (tunneling magnetoresistive) multilayer films is being developed in order to respond to the demands described above.

To help understand the magnetoresistive effect thin-film magnetic head having the CPP structure including the TMR multilayer films as the stacked MR films, one example of the conventional method for manufacturing such magnetic heads is now described by referring to FIG. 2.

Herein, the CPP (Current Perpendicular to Plane) structure refers to the structure that allows the sense current to flow perpendicularly to the film plane of the stacked MR films.

In the magnetoresistive effect thin-film magnetic head shown in FIG. 2, the stacked MR films having the cap layer as the top layer may be formed on top of the bottom shield layer, and the top shield layer may be formed on the stacked MR films. For the magnetoresistive effect thin-film magnetic head having the CCP structure, the gap length for the magnetic head may generally be set to be equal to the distance between the bottom shield layer and top shield layer as shown in FIG. 2 (d).

In the conventional method for fabricating the magnetoresistive effect thin-film magnetic heads described above, the gap length for the magnetic head may be set by following the steps that will be described below.

As a first step of the method, as shown in FIG. 2 (a), the bottom shield layer, the buffer layer, the stacked MR films, the cap layer and other layers may be formed on a substrate (not shown) in the order of the above listing. Then, the micro fabrication process may be performed. Here, the “micro fabrication process” is the process by which the stacked MR films in the form of a trapezoid having slanted sides as shown in FIG. 2 (b) may be formed by using the ion milling apparatus, RIE (reactive ion etching) apparatus or any other similar apparatus. Following the micro fabrication process, at least one insulating layer may be formed on the stacked MR films having the cap layer as the top layer. For example, an Al₂O₃ layer may be formed as the insulating layer (FIG. 2 (b)), and then a hard bias layer and another insulating layer may be formed in that order on the upper side of the Al₂O₃ layer (as shown in FIG. 2 (c)).

The flattening process, which is also known as the exposing process, may then be performed. Here, the flattening process refers to the process by which the bottom shield layer may be exposed by removing part of the insulating layer formed on the cap layer by using the CMP (Chemical Mechanical Polishing) technique or IBE (Ion Beam Etching) technique (FIG. 2 (d)).

In the state as shown in FIG. 2 (d), that is, in the state in which the cap layer has been removed (by using the etching process) until it will have reached the predetermined thickness, the gap length for the magnetic head may finally be determined in accordance with the conventional method (as disclosed in Japanese patent application now published under No. 2003-203313). FIG. 2 (e) is a schematic diagram that illustrates how the gap length can be determined according to the conventional method for fabricating magnetoresistive effect thin-film magnetic heads as described above. In FIG. 2 (e), the left side corresponds to the state in FIG. 2 (b), and the right side corresponds to the state in FIG. 2 (d).

It should be noted, however, that in the conventional method for fabricating magnetoresistive effect thin-film magnetic heads such as the one described above, the gap length may be controlled by removing part of the cap layer and thereby exposing the cap layer until it reaches the predetermined thickness using the CMP or IBE method. For the reasons described above, the conventional method has a number of problems.

Firstly, it is difficult to provide the film thickness of between 5 nm and 10 nm as required for the cap layer by using the etching process, without causing any variations in the film thickness for the different substrates.

The cap layer, which is usually made of any non-magnetic materials, is provided for preventing the magnetic films, such as the free layer, which form the stacked MR films below the cap layer from making contact with gases that may cause damages such as oxidation. The cap layer is also provided for preventing the stacked MR films below the cap layer and the top shield layer of any soft magnetic materials formed on the cap layer from interacting with each other magnetically.

If the predetermined film thickness as required cannot be obtained, therefore, it would be impossible to enable the cap layer to provide the required functions as described above. On the other hand, if the film thickness exceeds the predetermined thickness, causing the gap length to be larger, the resolution (or resolving ability) of the head would be lowered.

For example, when the required film thickness is determined by etching the cap layer with the CMP process, the high precision film thickness control is required. Thus, slurry having its average particle diameter of preferably less than 50 nm, more preferably less than 10 nm, must be used. Although such slurry may be used to regulate the polishing speed, however, it would still be difficult to control the film thickness of between 5 nm and 10 nm required for the cap layer without causing any variations in the film thickness.

Similarly, even when the required film thickness is determined by etching the cap layer with the IBE process, variations in the formed film thickness have occurred for each of the different substrates because ion beams have been applied against those substrates each having a particular size (such as the substrate having the size of φ8 inches) at a particular incident angle with regard to the substrates.

Furthermore, as the variations in the film thickness described above would occur when the cap layer is etched by using the CMP or IBE process, it must be considered in advance that such variations would occur, and some etching margin must be provided by depositing the cap layer more thickly than as required.

More specifically, some degree of preliminary thickness must be provided in advance, in addition to the optimal thickness of the cap layer (such as 5 nm to 10 nm) from which the gap length of the magnetoresistive effect thin-film magnetic head can be determined.

### OBJECTS AND SUMMARY

The present disclosure is directed toward providing a method of fabricating a magnetoresistive effect thin-film magnetic head including the magnetoresistive effect element having the CPP structure, wherein the gap length can be optimized with the high precision by minimizing any possible variations in the gap length, and is also directed toward providing such magnetoresistive effect thin-film magnetic heads fabricated by the above method. According to a method of the present disclosure, the gap length can be optimized with the high precision without providing any preliminary thickness as the etching margin on the cap layer in advance, and therefore the magnetoresistive effect thin-film magnetic head having the smallest gap length can be obtained. The magnetoresistive effect thin-film magnetic heads thus manufactured has the smallest gap length optimized with the high precision without causing any variations in the film thickness.

In order to solve the problems described above, the present disclosure proposes to provide a magnetoresistive effect thin-film magnetic head in which the stacked magnetoresistive effect thin-films having the cap layer as the top layer may be formed on a bottom shield layer on which a top shield layer will be formed, wherein the soft magnetic layer made of a soft magnetic material may be formed on the cap layer before the top shield layer is formed, and the top shield layer may then be formed on the part of the soft magnetic layer that has been exposed by the flattening process, and wherein the soft magnetic layer as coupled with the top shield layer can act the top shield layer.

In order to solve the problems described above, in addition, the present disclosure proposes to provide a method for fabricating a magnetoresistive effect thin-film magnetic head, wherein the method comprises the steps of forming the bottom shield layer on a substrate, forming, on the bottom shield layer, the stacked magnetoresistive effect thin films having the cap layer as the top layer, forming the soft magnetic layer made of any soft magnetic material on the cap layer, performing a micro fabrication process, followed by forming at least one insulating layer on the stacked magnetoresistive effect thin-films having the cap layer as the top layer on which the soft magnetic layer has been formed, removing part of the insulating layer formed on the soft magnetic layer and thereby exposing the soft magnetic layer, and forming the top shield layer on the surface of the exposed soft magnetic layer.

In accordance with a magnetoresistive effect thin-film magnetic head and method for fabricating such magnetic heads of the present disclosure, the soft magnetic layer consisting of any soft magnetic material may be formed on the cap layer before the top shield layer is formed, the top shield layer may then be formed on the soft magnetic layer, and the soft magnetic layer as coupled with the top shield layer can act as the top shield layer.

As opposed to the conventional method for manufacturing the magnetoresistive effect thin-film magnetic head having the CCP structure, the present disclosure allows the gap length to be determined without having to etch the cap layer by using the CMP or IBE process.

In accordance with the present disclosure, the gap length extending from the bottom shield layer to the top shield layer may be determined as the length extending from the upper side of the bottom shield layer to the upper side of the cap layer (the side on which the soft magnetic layer made of the soft magnetic material is formed) at the time when the stacked magnetoresistive effect films including the cap layer is initially formed.

In this manner, the gap length for the magnetoresistive effect thin-film magnetic head having the CCP structure can be determined with the high precision at the time when the stacked magnetoresistive effect thin films having the particular thickness are formed.

In addition, as opposed to the conventional method, there is no need of providing the etching margin by forming the cap layer more thickly than the optimal thickness.

In accordance with the present disclosure, the soft magnetic layer consisting of the soft magnetic material is formed on the cap layer, and the top shield layer is then formed on the surface of the soft magnetic layer as described above. Thus, the soft magnetic layer formed on the cap layer can have the function equivalent to the top shield layer. The gap length may be determined by forming the cap layer to the particular thickness, and the soft magnetic layer formed on the cap layer may be used as the etching margin. In this way, the yield can be improved, and the productivity can be enhanced accordingly.

### BRIEF DESCRIPTION OF DRAWINGS

FIGS. 1 (a) through (d) illustrate one example of the method for fabricating a magnetoresistive effect thin-film magnetic head having the CCP structure in accordance with one embodiment of the present invention, in which (d) is a schematic diagram illustrating the cross section of the magnetoresistive effect thin-film magnetic head having the CCP structure according to an embodiment of the present invention, and (e) is a schematic diagram illustrating how the gap length may be determined at the time when the magnetoresistive effect thin-film magnetic head having the CCP structure is fabricated by following the steps of (a) through (d) in accordance with an embodiment of the present invention; and

FIGS. 2 (a) through (d) illustrate one example of the conventional method for fabricating a magnetoresistive effect thin-film magnetic head having the CCP structure in accordance with the art, in which (d) is a schematic diagram illustrating the cross section of the magnetoresistive effect thin-film magnetic head having the CCP structure according to the art, and (e) is a schematic diagram illustrating how the gap length may be determined at the time when the magnetoresistive effect thin-film magnetic head having the CCP structure is fabricated by following the steps of (a) through (d) in accordance with the art.

### DETAILED DESCRIPTION OF THE PREFERRED EMBODIMENTS

Embodiments of the present invention will now be described by referring to the accompanying drawings.

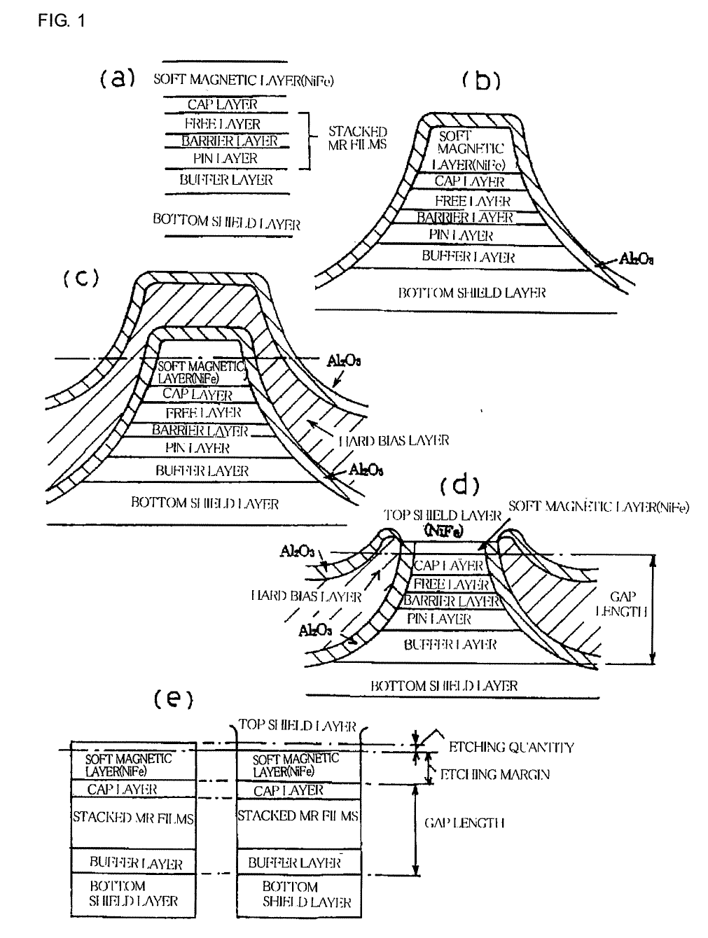

Referring first to FIGS. 1 (a) through (e), the magnetoresistive effect thin-film magnetic head and the method for fabricating such heads are described in accordance to embodiments of the present invention.

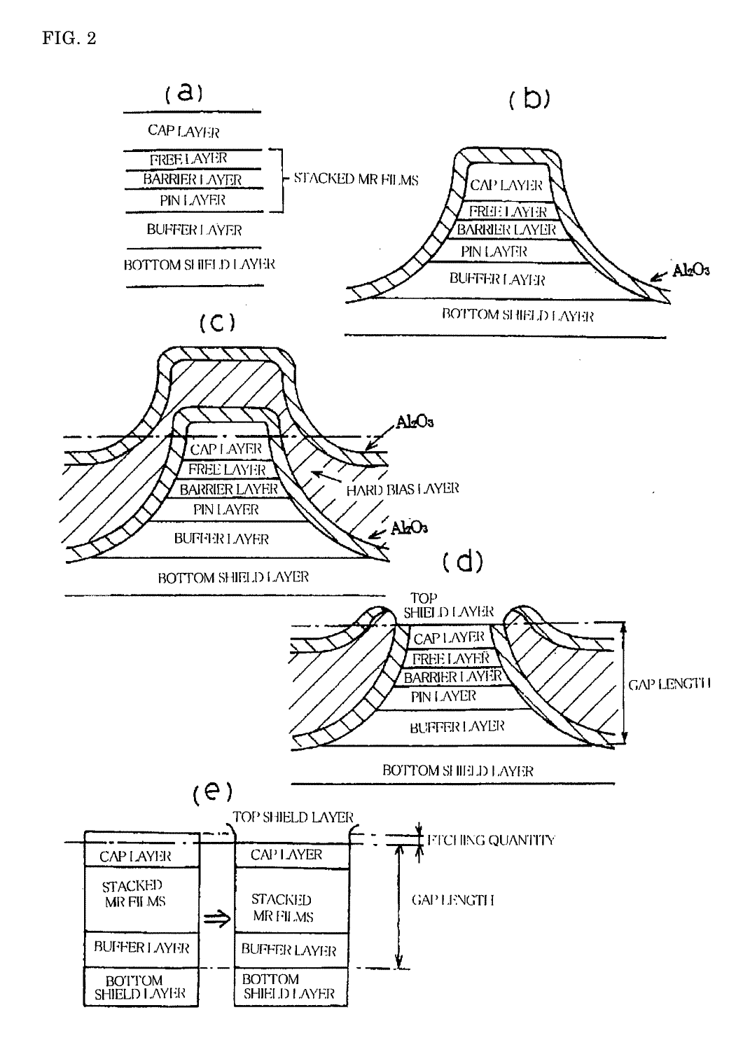

As for the example of the conventional method shown in FIG. 2 (a), the bottom shield layer may be formed on a substrate (not shown) by using any suitable plating method, and then the buffer layer, the stacked MR films, the cap layer and other layers may be formed on the bottom shield layer in that order of the above listing.

Herein, the buffer layer is the layer that provides the good effect on the formation of a pin layer as one of the layers included in the stacked MR films formed on the buffer layer. For example, it is the layer that may improve the properties of the pin layer such as its orientation and the like.

In general, the stacked MR films includes the pin layer as the magnetized fixed layer, the barrier layer as the insulating layer, and the free layer as the magnetized free layer, in which the cap layer may include a thin film of tantalum (Ta), for example.

In the method shown in FIG. 1 (a), the soft magnetic layer made of any soft magnetic material (such as NiFe in the example shown) may be formed on the cap layer (such as the Ta layer in the example shown).

Specifically, as shown in FIG. 1 (d), the magnetoresistive effect thin-film magnetic head and the method for fabricating such heads may be characterized in that the soft magnetic layer made of any soft magnetic material may be formed as a thin film on the cap layer formed on the upper side of the stacked MR films, the flattening process may then be performed, and the top shield layer may be formed on the soft magnetic layer so that the top shield layer can be coupled with the soft magnetic layer, thereby allowing the soft magnetic layer to act as the single top shield layer.

The top and bottom shield layers may be provided so that they can prevent any disturbances due to the external magnetic fields from occurring in the magnetizing direction of the stacked MR films formed between the top and bottom shield layers.

Each layer of the stacked MR films including the soft magnetic layer being formed on the cap layer may be formed by using the multi-channel type sputtering apparatus, for example, in which the uniformity of the thickness within the substrate may be provided with the precision of less than 1% when the film is formed on the φ8-inch substrate.

In the magnetoresistive effect thin-film magnetic head and the method for fabricating such heads, therefore, the cap layer having the optimal film thickness can be provided under the condition of the film thickness uniformity of less than 1%, and then the gap length of the magnetoresistive effect thin-film magnetic head can be determined with the high precision at the time of the formation of the soft magnetic layer on the cap layer, as shown in FIG. 1 (c).

Then, as for the conventional case described in FIGS. 2 (b) and (c), the micro fabrication process may be performed. This micro fabrication process is the process by which the stacked MR films in the form of the trapezoidal shape having the slanted sides may be formed as shown in FIG. 1 (b). For example, the micro fabrication process may occur using the ion milling device, RIE (reactive ion etching) device or similar devices.

Following the micro fabrication process, at least one insulating layer may be formed on the stacked MR films having the cap layer as the top layer on which the soft magnetic layer may be formed. Specifically, an Al₂O₃ layer, for example, may firstly be formed as the insulating layer (FIG. 1 (b)), a hard bias layer may then be formed on the upper side of the insulating layer, and a further insulating layer may then be formed on the hard bias layer (FIG. 1 (c)).

In the example shown in FIG. 1 (b), the hard bias layer that is made of any hard magnetic material such as CoPt alloys may be formed, on which the insulating layer that is made of any non-magnetic insulating materials may then be formed. The hard bias layer is provided to define the magnetizing direction of the free layer, and the insulating layer is provided to improve the insulation against the top shield layer and other layers. In the example shown in FIG. 1 (b), the Al₂O₃ layer may be formed as the insulating layer.

Then, the flattening process such as CMP (Chemical Mechanical Polishing) or IBE (Ion Beam Etching) may occur, by which part of the insulating layer formed on the soft magnetic layer may be removed, making the soft magnetic layer exposed (FIG. 1 (d)). Specifically, in the example shown, in which the soft magnetic layer is formed on the cap layer, and the insulating layer, the hard bias layer and so on are then formed on the cap layer, the soft magnetic layer can be exposed by removing part of the insulating layer.

In this manner, the soft magnetic layer formed on the cap layer formed on the stacked MR films may be made to contact the top shield layer.

At this time, part of the thickness of the soft magnetic layer formed on the cap layer may be used as the etching margin, as shown on the right side of FIG. 1 (d) and FIG. 1 (e).

Then, the soft magnetic layer formed on the cap layer and partly exposed as described above may have the top shield layer formed thereon so that the top shield layer can make contact with the surface of the soft magnetic layer as shown in FIG. 1 (d). In this way, the soft magnetic layer as coupled with the top shield layer can act as the top shield layer.

Typically, the top shield layer may be made of any one of the soft magnetic materials such as Permalloy (NiFe). Otherwise, it may be made of any one of Co family amorphous magnetic films or any one of the Fe-family fine particle magnetic films.

In the following description, examples of the respective film thickness and material for each of the buffer layer, stacked MR films, and cap layer that may be formed by using the multi-channel type sputtering apparatus are shown.

Buffer layer: 5 nm (NiFeCr)

Stacked MR films: 35 nm (PtMn/CoFe/Ru/CoFe/Al₂O₃/CoFeB)

Cap layer: 5 nm (Ta)

The top and bottom shield layers between which the intermediate stacked MR films are sandwiched may be formed from Permalloy (NiFe) so that they can have the thickness in the order of 100 nm by using any of the appropriate thin film forming method such as the plating method.

During the steps described above, the stacked magnetoresistive effect thin-films having the cap layer as the top layer will be formed on the bottom shield layer, on the upper side of which the top shield layer will then be formed. The magnetoresistive effect thin-film magnetic head thus obtained has the gap length that can be as small as 45 nm.

According to embodiments of the present invention as described above, there is no need of determining the gap length for the magnetic head by etching the cap layer itself by using the CMP or IBE method, as opposed to the conventional method for fabricating the magnetoresistive effect thin-film magnetic heads.

That is, the method for fabricating the magnetoresistive effect thin-film magnetic heads according to embodiments of the present invention allows the gap length to be determined with the high precision by controlling the film thickness of the stacked MR films at the time when they are formed.

It may be appreciated from the foregoing description that the structures, shapes, sizes (thickness) and relative positional relationships that have been described in connection with the embodiments of the present invention are only presented in general forms so as to enable those skilled in the art to understand and practice the present invention, and the specific values and types of the materials described in connection with the embodiments of the present invention are only presented by way of examples. It should be understood, therefore, that the present invention is not limited to those embodiments described herein, which may be changed or modified in various ways without departing from the spirit and scope of the invention as defined in the appended claims.

1. A magnetoresistive effect thin-film magnetic head comprising a bottom shield layer, the stacked magnetoresistive effect thin films formed on the bottom shield layer, a cap layer formed as a top layer on the bottom shield layer, and a top shield layer formed on the stacked magnetoresistive effect films, wherein the magnetoresistive effect thin-film magnetic head further comprises:
a soft magnetic layer comprising a soft magnetic material formed on the top layer prior to the formation of the top shield layer, the soft magnetic layer having a portion being exposed during a flattening process and the top shield layer being then formed on the exposed portion of the soft magnetic layer so that the soft magnetic layer thus coupled with the top shield layer is adapted to act as the top shield layer.

2. A method of forming a magnetoresistive effect thin-film magnetic head comprising:
forming a bottom shield layer on a substrate;
forming stacked magnetoresistive effect thin films including a cap layer as a top layer on the bottom shield layer;
forming a soft magnetic layer comprising any soft magnetic material on the cap layer;
performing a micro fabrication process for the soft magnetic layer thus formed in the preceding step;
forming at least one insulating layer on the stacked magnetoresistive effect thin films including the soft magnetic layer formed on the cap layer as the top layer, following the step of the micro fabrication process;
removing part of the insulating layer formed on the soft magnetic layer so that the soft magnetic layer is exposed; and
forming the top shield layer on the surface of the exposed soft magnetic layer.

3. The magnetoresistive effect thin-film magnetic head according to claim 1, wherein the soft magnetic layer consists of the soft magnetic material formed on the top layer prior to the formation of the top shield layer.

4. The method of forming a magnetoresistive effect thin-film magnetic head according to claim 2, wherein the soft magnetic layer consists of any soft magnetic material on the cap layer.
